(19) United States
(12) Patent Application Publication
(10) Pub. No.: US 2012/0274039 A1
(43) Pub. Date: Nov. 1, 2012

(54) Walk baby walk

(76) Inventor: Tymond Betrond Goodwin, Rockhill, SC (US)

(21) Appl. No.: 13/064,907

(22) Filed: Apr. 26, 2011

(51) Int. Cl. B62B 7/12

(52) U.S. Cl. 280/87.051

(57) ABSTRACT

A baby walker that allows the baby to walk using his or her own feet in an upright position without having to bend over. This is a baby walker that you don't have to push or sit down inside which stops the baby from running into walls. The baby walker helps keep the childs spine in right alignment and build the legs much faster than conventional walkers. The baby walker is made with two u-shaped swivel caster polyurethane wheels with a 4 inch stem being ½ inches in diameter, which scrolls back and forth on a 5 ft adjustable metal or plastic pole that stands on four 3 ft-6 inch adjustable metal or plastic poles (legs) being ¾ inches in diameter. The baby walker also has one V-shaped hand bar that is 6 inches in length with a 4 inch metal or plastic stem being ½ inches in diameter that attaches to the 4 inch stem of the u-shaped swivel caster polyurethane wheels. This allows the baby to grip the hand bars and walk back and forth.

### FIELD OF THE INVENTION

The present invention is a baby walker that allows the baby to walk in an upright position without running into walls or anything else for that matter.

### BACKGROUND OF THE INVENTION

Relates to a baby walker that allows that baby to make a 360″ turn an walk in an upright position. As stated in the specifications in point (4). The walk baby walk stops the baby from running into walls.

### REFERENCE TO PRIOR ART

Their has been a variety of baby walkers made to help babies walk but they all cause the baby to run into walls. Most push walkers cause the baby to bend over when he or she pushes it. This some times cause problems with the baby spine and posture. The walkers design for babies to sit down inside normally cause problems with the babies legs. The walk baby walk is a unique walker an allows the baby to walk in an upright position.

### SUMMARY OF THE INVENTION

The object of the invention is to provide a baby walker that that causes the baby to walk in an upright position without running into walls and other objects. The invention also provides protection to the baby spine and legs. The invention further allows the baby to walk continuously without having to be turned around and build the baby legs much faster than conventional walkers.

### BRIEF DESCRIPTION OF THE DRAWINGS

FIG. 1 is a full view of the walk baby walk illustrating the two U-shaped swivel caster polyurethane wheels with the stem rolling across FIG. 4 which is the 5-ft metal pole also showing FIG. 2 (hand bar with 4 inch stem) being attached to FIG. 3 (two U-shaped swivel caster polyurethane wheels with stem also showing FIG. 5 (4 adjustable metal legs) being attached to FIG. 4 (5 ft adjustable metal pole with 4 leg stems).

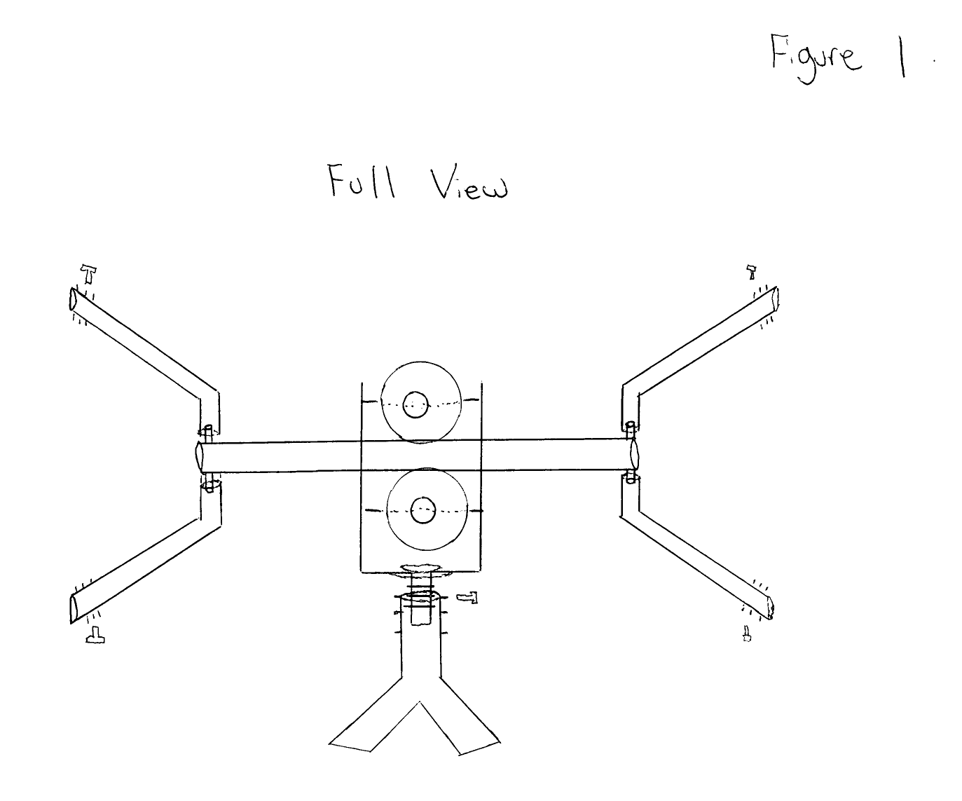

FIG. 2 is a front view of the true Y-shaped hand bar with the pin adjustment holes.

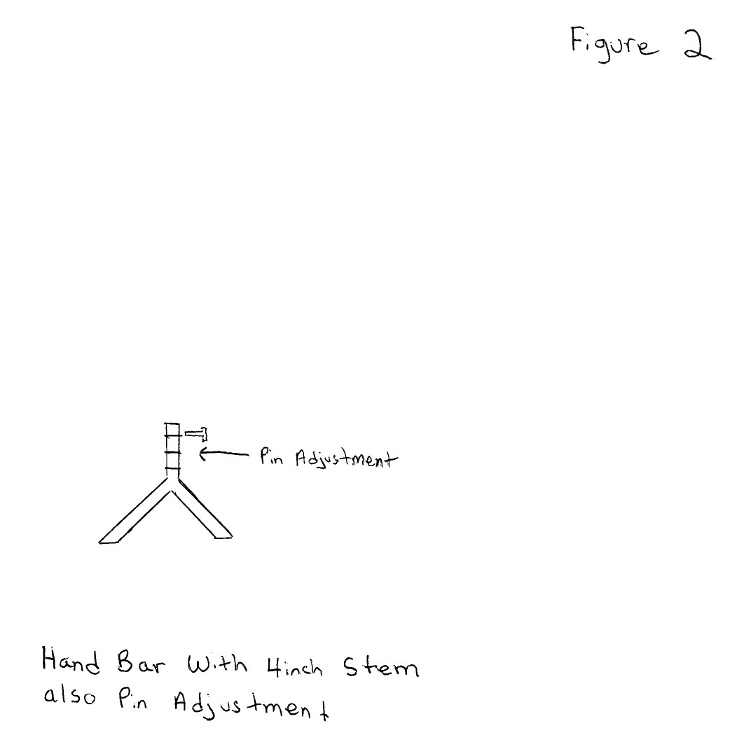

FIG. 3 is a side view of the two U-shaped swivel caster polyurethane wheels with stem

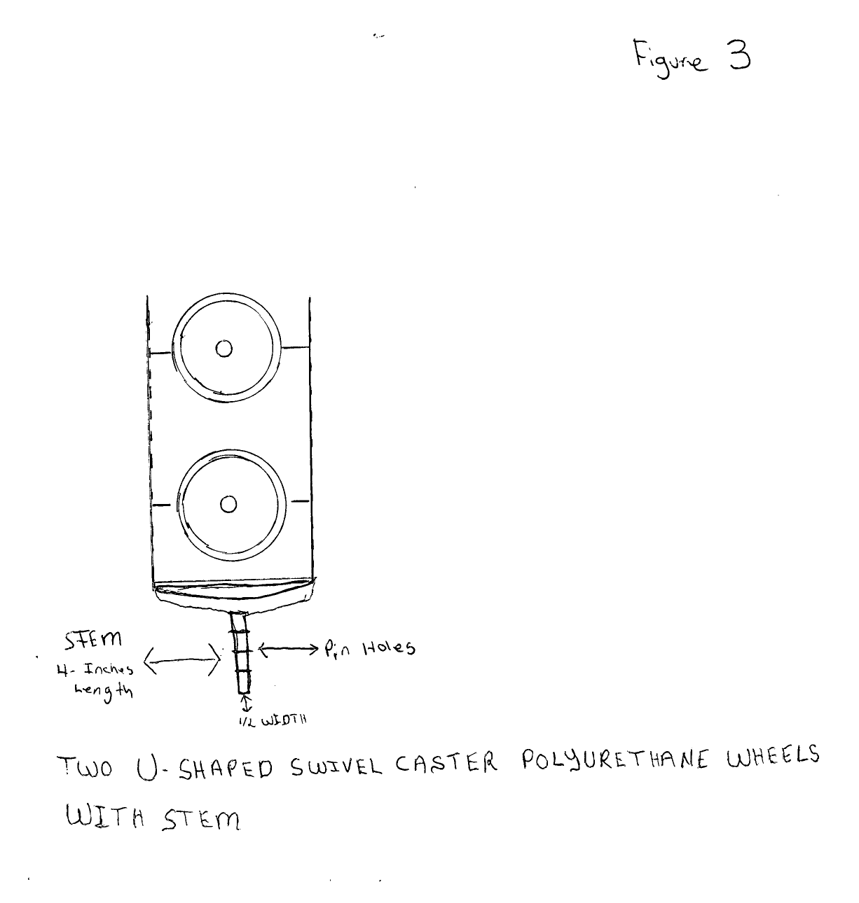

FIG. 4 is a front view of the 5 foot adjustable metal pole with fastener stems

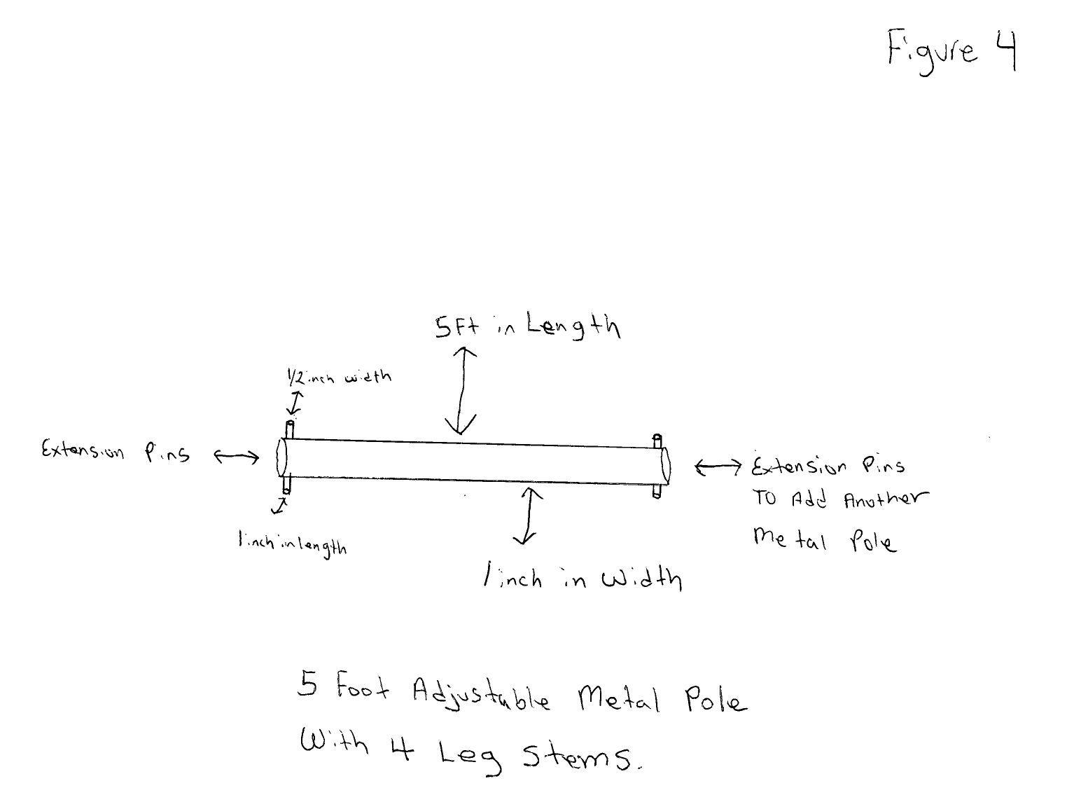

FIG. 5 is a front view of all 4-adjustable metal legs also showing the 3 adjustment holes for pin placement on the side.

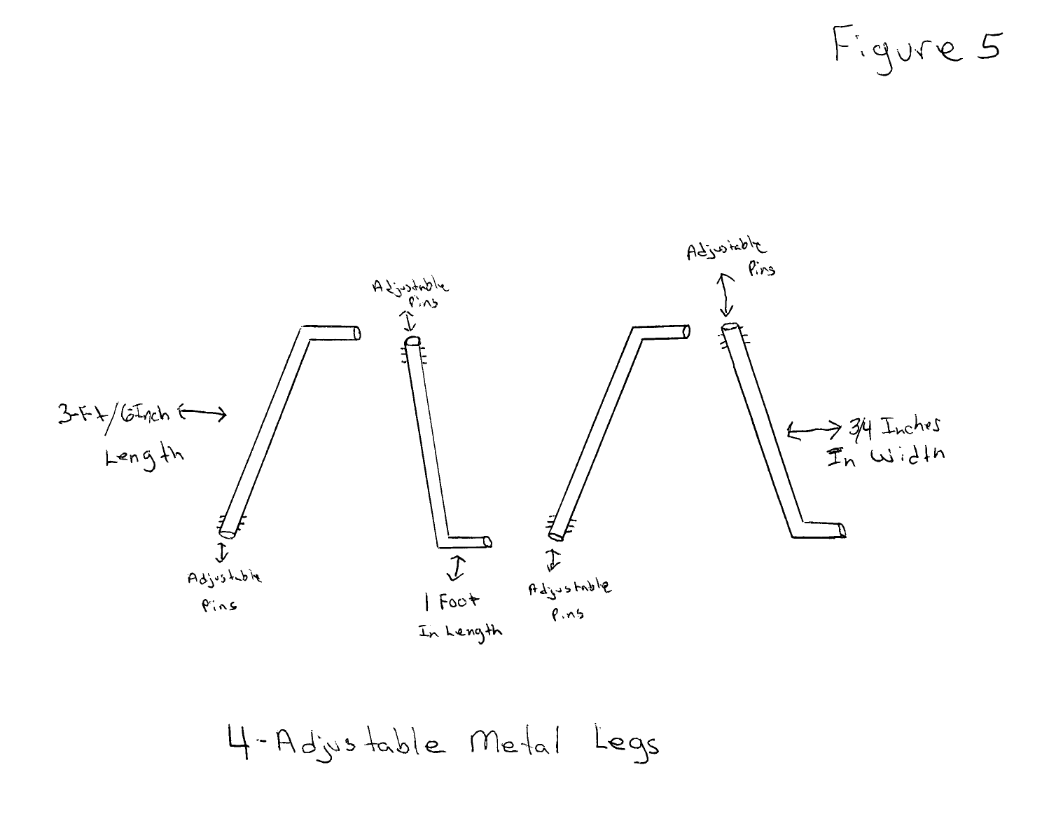

1-13. (canceled)

14. A baby walker which allows the baby to stand up and walk on there own two feet in an upright position without having to bend over, then make a 360 degree turn by holding onto the true Y-shaped hand bars.

15. A baby walker made with two U-shaped swivel caster polyurethane wheels scrolling back and forth across a 5 ft metal pole or any other type of pole, with each end of the 5 ft pole being connected to two metal poles or any other type of pole standing 3 ft-6 inches in height.

16. A baby walker made withy a true Y-shaped hand bar with an adjustable pin.
